(19) United States
(12) Patent Application Publication
(10) Pub. No.: US 2025/0210950 A1
(43) Pub. Date: Jun. 26, 2025

(54) CABLE FIXING SYSTEM

(71) Applicant: Eaton Intelligent Power Limited, Dublin (IE)

(72) Inventors: Erik Emmanuel Garcia Canseco, Iztapalapa (MX); Luis Manuel Alba Regalado, Mexico City (MX); Elías Martínez Valerio, Nezahualcoyotl (MX); Pedro Mancilla Martinez, Cuautitlan Izcalli (MX); Hilda Luisana Moreno Cardenas, Mexico City (MX)

(21) Appl. No.: 18/990,085

(22) Filed: Dec. 20, 2024

Related U.S. Application Data
(60) Provisional application No. 63/613,646, filed on Dec. 21, 2023.

(51) Int. Cl. H02G 3/04

(52) U.S. Cl. CPC H02G 3/0462

(57) ABSTRACT

A cable fixing system including a plug including a handle body and a contact assembly disposed at least partially within the handle body. A gland nut assembly includes a gland nut configured for attachment to the handle body of the plug. A clamp is mountable on the gland nut to secure a cable to the gland nut. The clamp includes a single unitary body.

### CLAIM OF PRIORITY

This application claims the benefit of U.S. Provisional Patent Application Ser. No. 63/613,646, filed on Dec. 21, 2023, the entire content is hereby incorporated by reference.

### FIELD OF THE DISCLOSURE

The present disclosure generally relates to a cable fixing system, and more particularly, to a cable fixing system including a gland nut assembly and a plug body.

### BACKGROUND OF THE DISCLOSURE

Plugs, receptacles and connectors are used indoors and outdoors to supply power to various electrical equipment. In particular, explosion-proof receptacles and plugs can be used with portable electrically operated devices such as motor generator sets, compressors, heating and cooling units, welders, conveyors, portable tools, lighting systems and similar equipment. For example, CPP series plugs may be used with CPS series receptacles in corrosive or hazardous locations. Such locations may include, but are not limited to, petroleum refineries, chemical and petrochemical plants, and other process industry facilities subject to hazardous conditions. Also, CPH series plugs can be used with CES series receptacles in hazardous locations. As these types of plugs and receptacles are used in hazardous locations, their applications may also require their removal, adjustment, replacement or frequent maintenance of the plugs/receptacles and related equipment.

Referring to FIGS. 1A and 1B, a conventional cable fixing system 1 is shown including a plug 3 and a gland nut assembly 5. In one embodiment, the gland nut assembly 5 is configured for connection to a power source (not shown), and the plug 3 is configured for connection to an electrical cord (not shown) of a device to be powered. When the plug 3 is connected to the cable gland nut assembly 5, power is provided to the device. The gland nut assembly 5 comprises an 8-part assembly including a gland nut 7 for connecting the plug to the electrical cord/device, first and second clamp members 9 engagable with opposite sides of the gland nut, a pair of screws 11 receivable through openings in the clamp members and gland nut, a pair of nuts 13 receivable through openings in the clamp members and gland nut and configured to receive shafts of the screws for locking the clamp members to the gland nut, and a locking screw 15 for securing the gland nut to a cable C. Therefore, the cable fixing system 1 comprises eight (8) components. In particular, the eight components comprise specialized components that are constructed specifically for the assembly of the cable fixing system 1.

The cable fixing system 1 is assembled by first inserting the cable C through a longitudinal passage in the plug 3. The gland nut 7 is then received around a portion of the cable C extending from an end of the plug 3. The gland nut 7 may then be secured in place around the cable C by inserting the locking screw 15 into a locking feature 17 on the gland nut. The clamp members 9 may then be secured to the gland nut 7 by inserting the screws 11 and nuts 13 into the respective openings in the clamp members 9 and gland nut. In particular, a first screw 11 and nut 13 pair are inserted into the openings in the clamp members 9 and gland nut 7, then the system 1 is turned and the second screw and nut pair are inserted into the other openings in the clamp members 9 and gland nut. Thus, the assembly of the cable fixing system 1 can be time consuming and requires specifically constructed components.

### SUMMARY OF THE DISCLOSURE

In one aspect, a cable fixing system generally comprises a plug comprising a handle body and a contact assembly disposed at least partially within the handle body. A gland nut assembly comprises a gland nut configured for attachment to the handle body of the plug. A clamp is mountable on an exterior surface of the gland nut to engage and secure a cable to the gland nut. The clamp comprises a single unitary body.

In another aspect, a gland nut assembly for use in a cable fixing system generally comprises a gland nut configured for attachment to a plug. A clamp is mountable on an exterior surface of the gland nut to engage and secure a cable to the gland nut. The clamp comprising a single unitary body.

### BRIEF DESCRIPTION OF THE DRAWINGS

FIG. 1A is a separated view of a cable fixing system of the prior art;

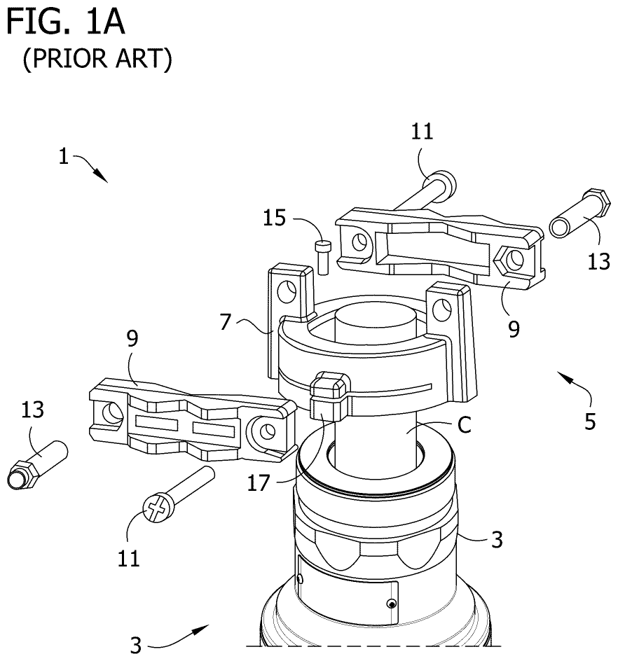

FIG. 1B is a fragmentary perspective view of the cable fixing system in FIG. 1A;

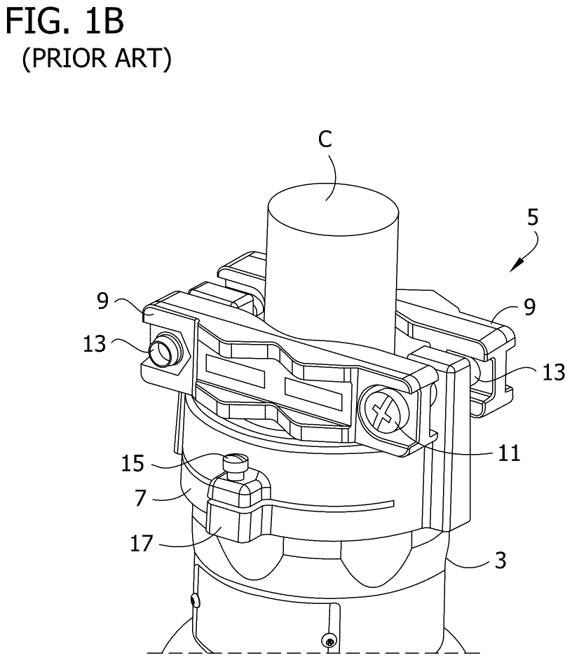

FIG. 2 is a front perspective view of a cable fixing system constructed according to the teachings of the present disclosure;

FIG. 3 is a rear perspective view of the cable fixing system;

FIG. 4 is a separated view of the cable fixing system;

FIG. 5 is a fragmentary vertical perspective view of the cable fixing system;

FIG. 6 is a separated view of a gland nut assembly of the cable fixing system;

FIG. 7 is a perspective view of a gland nut of the gland nut assembly;

FIG. 8 is a bottom perspective view of a clamp of the gland but assembly; and

FIG. 9 is a top view of the clamp.

### DETAILED DESCRIPTION OF THE DISCLOSURE

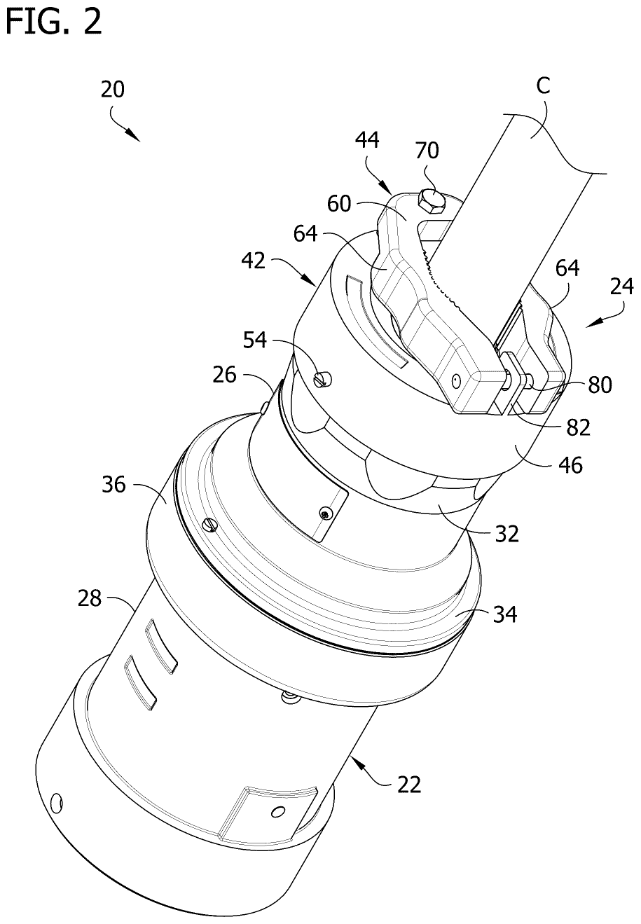

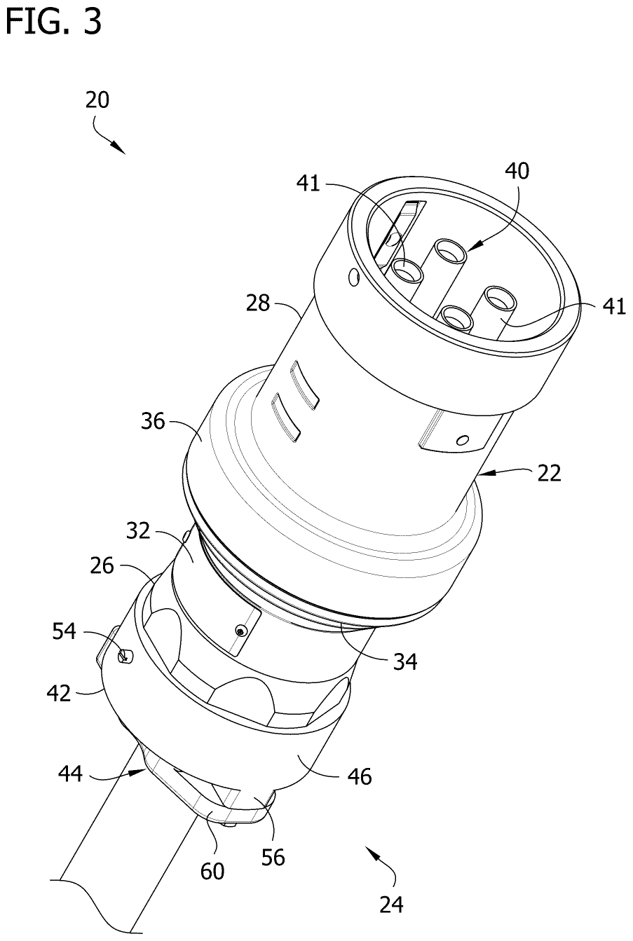

Referring to FIGS. 2 and 3, a cable fixing system constructed according to the teachings of the present disclosure is generally indicated at reference numeral 20. The cable fixing system 20 includes a plug, generally indicated at 22, and a gland nut assembly, generally indicated at 24, configured to mateably engage the plug and secure around a cable C received at least partially through the cable fixing system. The plug 22 is typically electrically connected to an electrical cord of an electrical device and configured for insertion into a receptacle (not shown) to electrically connect the plug to the receptacle. The receptacle is typically electrically connected to a power supply, although these may be reversed. As described herein, terms “proximal” and “distal” are used for non-limiting purposes to describe relative locations of the components of the plug 22 and the gland nut assembly 24 with the point of reference being the flow of power from the power supply through the cable fixing system 20 when the receptacle is electrically connected to the power supply and the plug 22 is electrically connected to the electrical device. Accordingly, the plug 22 is generally located proximal of the gland nut assembly 24, as used herein. The cable fixing system 20 may be constructed as a switch-rated connector, according to UL 1682, for example.

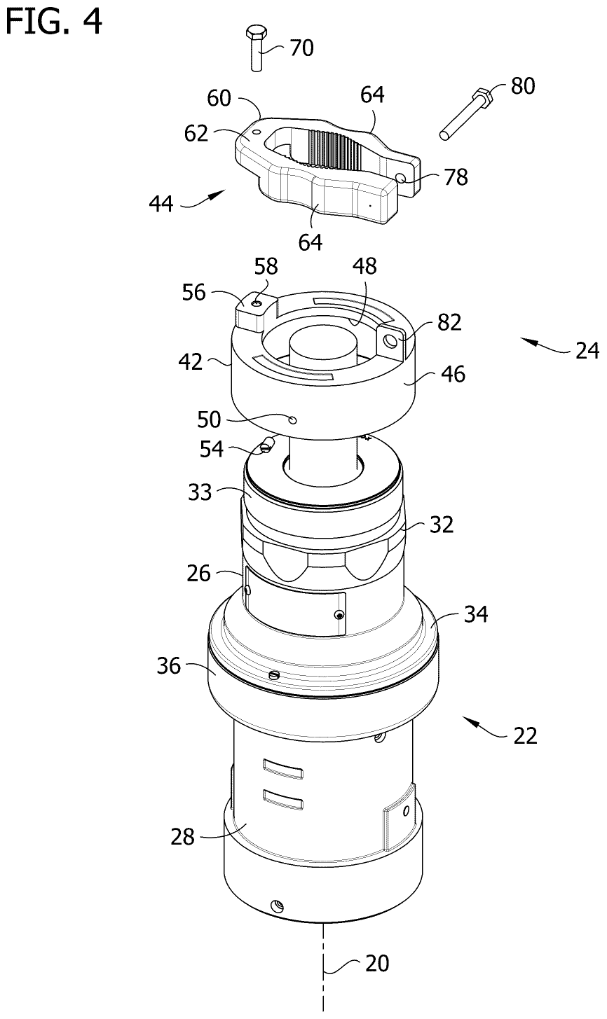

The plug 22 may comprises a 2-part housing assembly including a handle body 26 connecting the plug to the gland nut assembly 24 at a distal end of the handle body, and a sleeve 28 attached to a proximal end of the handle body and configured to mate with a connector port of the receptacle at a proximal end of the sleeve for establishing an electrical connection between the plug and the receptacle. The plug 22 has a plug axis PA (FIG. 4) extending between distal and proximal ends of the plug. The handle body 26 comprises a generally cylindrical member having a length extending along the plug axis PA. The cylindrical member includes a first portion 32 extending from a distal end of the plug 22. The first portion 32 may include external threads 33 (FIG. 4) for attaching the handle body 26 to the gland nut assembly 24 as will be discussed in greater detail below. In one embodiment, the first portion 32 extends over 50% of the length of the handle body. A second portion 34 of the handle body 26 extends from a proximal end of the first portion 32. The second portion 34 flares outward at a constant rate as it extends longitudinally in the proximal direction. Thus, a diameter of the second portion 34 at a proximal end of the second portion is greater than a diameter of the second portion at a distal end. A third portion 36 of the handle body 26 extends from a proximal end of the second portion 34. Along at least some segments of the third portion 36, the third portion has a generally constant outer diameter extending along an entire length of the third portion. The overall shape of the handle body 26, including the first, second and third portions 32, 34, 36, provides an ergonomic outer surface to facilitate grasping the handle body for attaching the handle body to the sleeve 28. In one embodiment, the plug 22 (i.e., handle body 26 and sleeve 28) may be formed from aluminum. However, the plug 22 may also be formed from other suitable materials without departing from the scope of the disclosure.

Referring to FIG. 3, a contact assembly 40 is disposed at least partially within the sleeve 28. The contact assembly 40 includes a plurality if contacts 41. The sleeve 28 defines a cylindrical housing that surrounds at least a portion of the contact assembly 40. The cylindrical housing of the sleeve 28 is sized and shaped for mating with the connector port of the receptacle. The sleeve 28 may be secured in the connector port by a locking arm (not shown) on the receptacle. However, the sleeve 28 could be secured to the receptacle by other means.

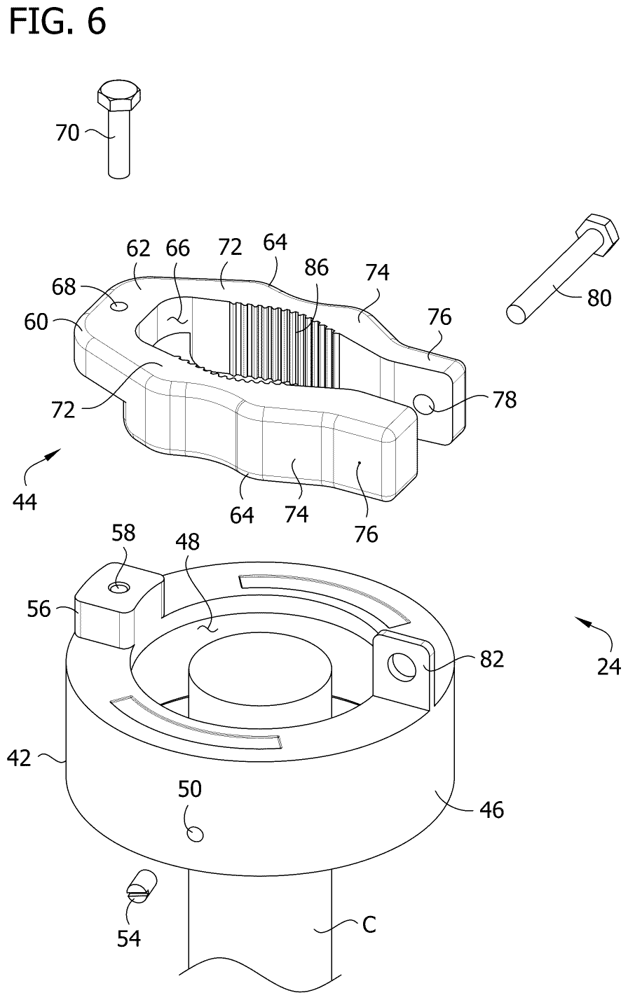

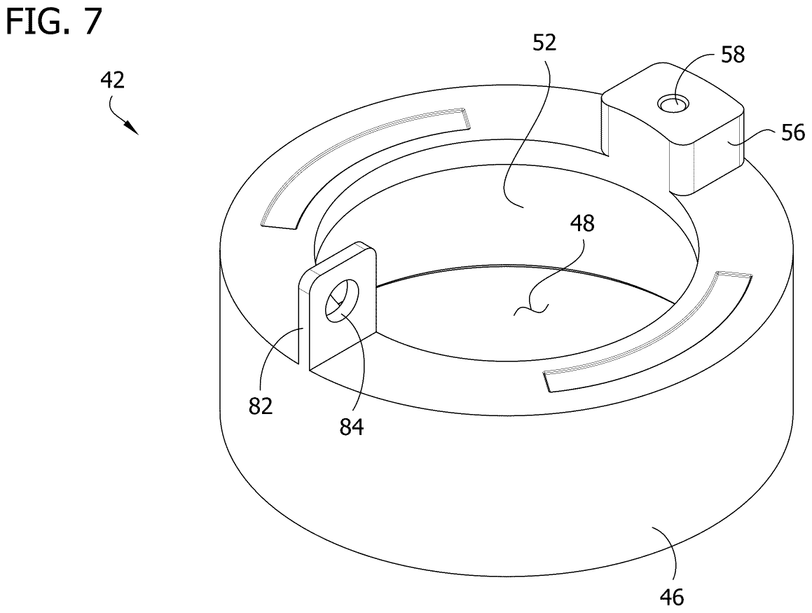

Referring to FIGS. 2-7, the gland nut assembly 24 comprises a gland nut 42 engageable with the plug 22 to attach the gland nut to the plug, and a clamp 44 mountable to the gland nut for securing the gland nut assembly to the cable C. In the illustrated embodiment, the gland nut 42 comprises a nut body 46 having an annular shape defining a passage 48 extending along an axis of the nut body. A hole 50 is formed in an outer circumferentially extending wall of the nut body 46 and extends through the wall and communicates with the passage 48 in the nut body. Internal threads 52 are provided on an inner circumferentially extending wall of the nut body 46 at a proximal end of the nut body. The internal threads 52 are configured for mating engagement with the external threads 33 on the handle body 26 for attaching the nut body 46 of the gland nut 42 to the plug 22. A set screw 54 (broadly, a locking screw) is receivable in the hole 50 in the nut body 46 and engageable with the external threads 33 on the handle body 26 to set the nut body in place on the handle body after the nut body has been threaded onto the handle body.

A support or holder 56 may be disposed on the nut body 46 and configured to locate the clamp 44 on the nut body. The support 56 is generally disposed on the nut body 46 and extends distally from a distal surface of the nut body. In one embodiment, the support 56 comprises a post defining a hole 58 extending axially through the post. In the illustrated embodiment, the support 56 is integrally formed with the gland nut 46. However, the support 56 could be formed separately from the gland nut 46 and suitably attached to the gland nut without departing from the scope of the disclosure. Additionally, the support 56 could have other configurations without departing from the scope of the disclosure.

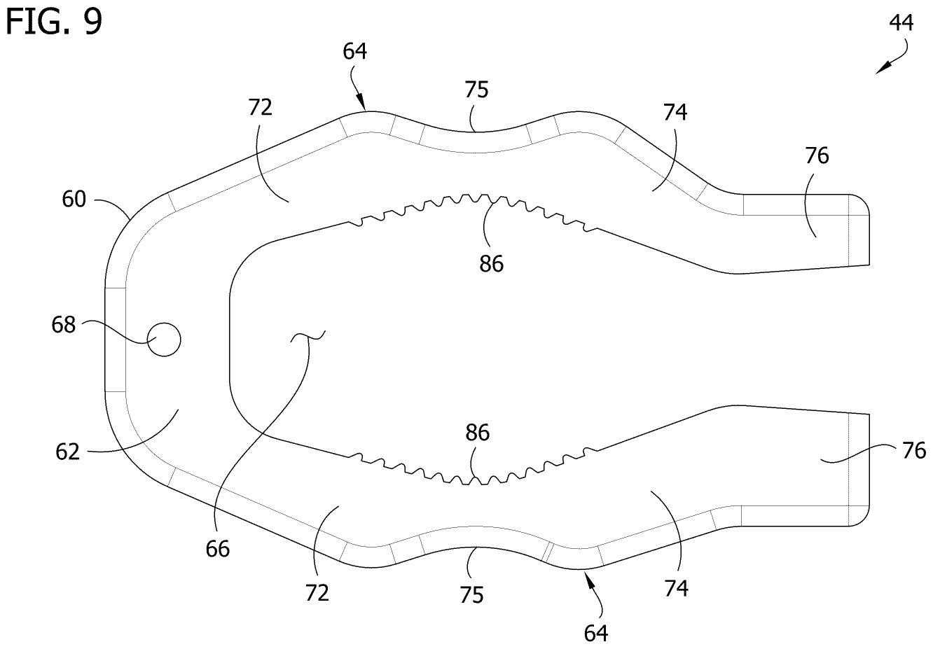

Referring to FIGS. 2-6, 8, and 9, the clamp 44 comprises a single, unitary body 60 configured to extend along diametrically opposite sides of the cable C to clamp the cable in place relative to the gland nut assembly 24. The clamp 44 may be formed from any suitable material. In one embodiment, the clamp 44 may be formed from aluminum. However, the clamp 44 may also be formed from other suitable materials without departing from the scope of the disclosure. In the illustrated embodiment, the clamp body 60 has a generally U-shape including a base 62 and a pair of arms 64 extending laterally from opposite ends of the base. An area 66 between the base 62 and arms 64 provides a space for receiving the cable C within the clamp 44. The base 62 comprises a member defining an opening 68 therein. The base 62 is configured to seat on a top of the support 56 to mount the clamp 44 to the gland nut 42. When the base 62 is seated on top of the support 56, the opening 68 in the base is alignable with the hole 58 in the support 56 so that a standard screw 70 can be inserted into the opening and hole to secure the clamp to the support.

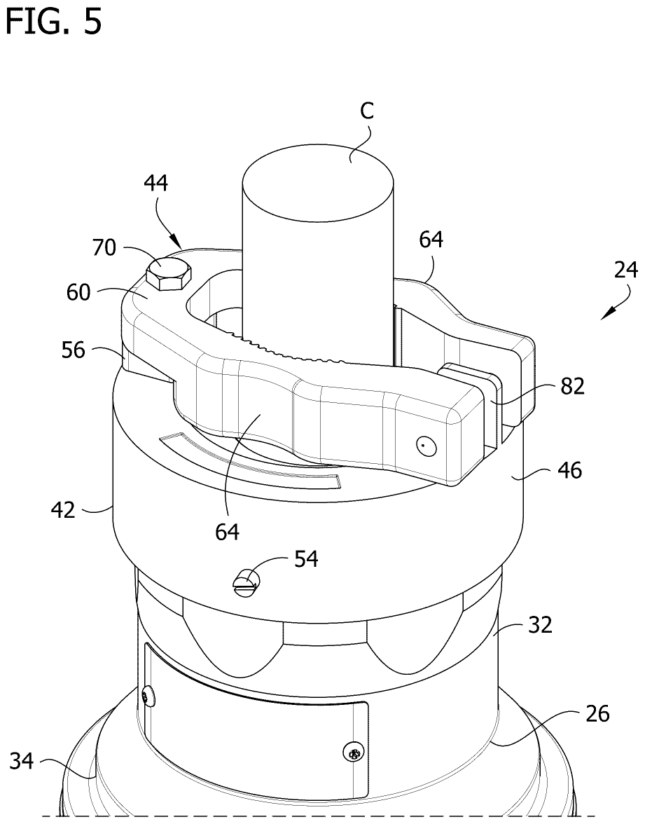

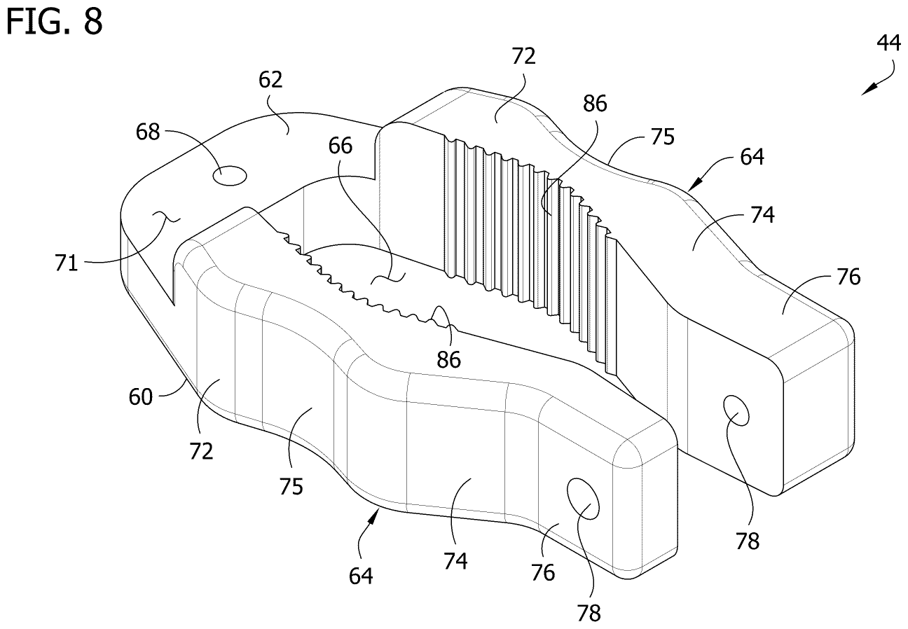

Referring to FIGS. 5, 6, 8, and 9, each arm 64 of the clamp 44 comprises an elongate member extending laterally from the base 62. In particular, each arm 64 extends laterally from the base 62 in a direction extending over the gland nut 42 when the clamp 44 is mounted on the gland nut. The arms 64 may have a height extending between upper and lower surfaces of the arms that is greater than a height of the base 62. Thus, a recessed area 71 (FIG. 8) may be formed between the base 62 and the arms 64. The recessed area 71 may be sized to receive the support 56 when the clamp 44 is mounted on the gland but 42. In the illustrated embodiment, a first portion 72 of each arm 64 extends from the base 62 at an obtuse angle such that the first portions of the arms generally extend away from each other as they extend from the base. However, the first portions 72 may extend from the base 62 at other angles without departing from the scope of the disclosure. A second portion 74 of each arm 64 extends from the first portion 72 over the gland nut 42 when the clamp 44 is mounted on the gland nut. In the illustrated embodiment, the second portion 74 extends from the first portion 72 at an obtuse angle such that the second portions of the arms 64 generally extend toward each other as they extend from the first portions 72. However, the second portions 74 may extend from the first portions 72 at other angles without departing from the scope of the disclosure. A juncture 75 between the first portion 72 and second portion 74 of each arm 64 defines a concave area on an outer surface of the arms. The concave area 75 provides an area for a user to grasp the clamp 44 when using the clamp with the cable fixing system 20. A third portion 76 of each arm 64 extends from the second portion 74 generally over the gland nut 42 when the clamp 44 is mounted on the gland nut. In the illustrated embodiment, the third portion 76 extends generally orthogonal to a longitudinal axis of the base 62. However, the third portions 76 could extend at other angles without departing from the scope of the disclosure. The third portions 76 terminate at the ends of the arms 64. The third portions 76 also define threaded holes 78 that are aligned and configured to receive a standard screw 80. Specifically, a first hole 78 in one of the arms 64 (e.g., the left arm in FIG. 8) extends entirely through the third portion 76 of the arm, and a second hole in the other arm (e.g., the right arm in FIG. 8) may extend only partially through the third portion of the arm. In the illustrated embodiment, the first hole 78 comprises a circular opening. However, the first hole 78 could have other configurations. For example, the first hole 78 may comprise a slotted opening. Additionally, it will be understood that the arms 64 could have other configurations (i.e., shapes and sizes) without departing from the scope of the disclosure.

An alignment tab 82 may be disposed on the nut body 46 and extend distally from the distal surface of the nut body. In the illustrated embodiment, the alignment tab 82 defines an opening 84 that is alignable with the first and second holes 78 in the arms 64. Therefore, inserting of the screw 80 through the first hole 78 in one of the arms 64 of the clamp 44 and through the opening 84 in the alignment tab 82 aligns the screw for insertion into the second hole 78 in the other arm 64 of the clamp. Thus, rotating the screw 80 in the holes 78 causes the arms 64 to move toward each other to clamp the arms around the cable C disposed between the arms. Interior surfaces of the arms 64 may include a series of indentations forming teeth 86 for engaging and biting into the cable C to further secure the clamp 44 around the cable. Because the arms 64 are anchored or fixed at one end by the base 62 and movable relative to each other at an opposite end, this allows the clamp 44 to flex inward and outward to accommodate a wide variety of cable sizes. For example, the clamp 44 may be configured to secure around cables C having a diameter between about 1 inch and about 1.5 inches. Additionally, only a single screw 80 is needed to secure the clamp 44 to the cable C.

The cable fixing system 20 of the present disclosure also provides an optimized design whereby the gland nut assembly 24 consists of only five (5) standard parts operable to secure a cable C in the system. In one embodiment, the five standard parts include the gland nut 42, the set screw 54, standard screw 70, the clamp 44, and standard screw 80. Therefore, the cable fixing system 20 of the present disclosure includes only readily available standard screws in addition to the gland nut 42 and clamp 44. Thus, customized fasteners are not required for the cable fixing system 20. This is contrary to conventional cable fixing systems which require the use of customized fasteners (screws and nuts) to assemble the system.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A cable fixing system comprising:
a plug comprising a handle body and a contact assembly disposed at least partially within the handle body; and
a gland nut assembly comprising a gland nut configured for attachment to the handle body of the plug, and a clamp mountable on an exterior surface of the gland nut to engage and secure a cable to the gland nut, the clamp comprising a single unitary body.

2. The system set forth in claim 1, wherein the contact assembly comprises a plurality of contacts.

3. The system set forth in claim 1, wherein the clamp is configured to extend along diametrically opposite sides of the cable.

4. The system set forth in claim 1, further comprises a single screw engageable with the clamp for securing the clamp around the cable.

5. The system set forth in claim 1, wherein the clamp comprises a base and a pair of arms extending laterally from the base.

6. The system set forth in claim 5, wherein an area between the base and arms provides a space for receiving the cable within the clamp.

7. The system set forth in claim 6, wherein the clamp is formed from aluminum.

8. The system set forth in claim 1, further comprising a support disposed on the gland nut, the support mounting the clamp to the gland nut.

9. The system set forth in claim 8, further comprising a standard screw extending through the support and clamp to secure the clamp to the support.

10. The system set forth in claim 1, wherein the gland nut assembly comprises less than eight (8) components.

11. The system set forth in claim 10, wherein the gland nut assembly consists of five (5) components.

12. A gland nut assembly for use in a cable fixing system comprising:
a gland nut configured for attachment to a plug; and
a clamp mountable on an exterior surface of the gland nut to engage and secure a cable to the gland nut, the clamp comprising a single unitary body.

13. The assembly set forth in claim 12, wherein the clamp is configured to extend along diametrically opposite sides of the cable.

14. The assembly set forth in claim 12, further comprises a single screw engageable with the clamp for securing the clamp around the cable.

15. The assembly set forth in claim 14, wherein the clamp comprises a base and a pair of arms extending laterally from the base.

16. The assembly set forth in claim 15, wherein an area between the base and arms provides a space for receiving the cable within the clamp.

17. The assembly set forth in claim 16, wherein the clamp is formed from aluminum.

18. The assembly set forth in claim 12, further comprising a support disposed on the gland nut, the support mounting the clamp to the gland nut.

19. The assembly set forth in claim 18, further comprising a standard screw extending through the support and clamp to secure the clamp to the support.

20. The assembly set forth in claim 12, wherein the gland nut assembly consists of five (5) components.
